(19) United States
(12) Patent Application Publication
(10) Pub. No.: US 2011/0211370 A1
(43) Pub. Date: Sep. 1, 2011

(54) Systems and Methods of Resonant DC/DC Conversion

(75) Inventors: Yuwei Luo, Naperville, IL (US); Bosheng Sun, Allen, TX (US); Ian Lloyd Bower, Bedford, TX (US)

(73) Assignee: TEXAS INSTRUMENTS INCORPORATED, Dallas, TX (US)

(21) Appl. No.: 12/715,342

(22) Filed: Mar. 1, 2010

(51) Int. Cl. H02M 3/335

(52) U.S. Cl. 363/21.02

(57) ABSTRACT

Systems and methods of resonant DC/DC conversion disclosed herein improve the basic resonant converter designs by proactively setting and coordinating the gate drive timings between the primary side and secondary side. By proactively setting and coordinating gate drives timings between the primary side and secondary side, both efficiency and transient performance optimizations may be achieved with or without diode emulation mode, depending on whether the switching frequency is below resonance or above resonance, and the nature of the load characteristics. If the switching frequency of the converter is determined to be at or below the resonance frequency, the output transistors may be configured to be fully active at or above a predetermined output load current. The turn-on timing of the output transistors is dependant on the load for a given output voltage, and is almost independent of input voltage. Turn-on timing may be significantly different at light load to no load.

### TECHNICAL FIELD

The present disclosure is generally related to electronics and, more particularly, is related to power supplies.

### BACKGROUND

A DC/DC converter is a switching power supply used to accept a DC input voltage and to supply a DC output voltage, usually at a regulated voltage or current. It is desirable in some power supply applications to operate at higher frequencies which permits physically smaller power supplies. To operate at these higher frequencies, transistor switching losses at turn-off and turn-on are preferably decreased.

Decreasing switching losses may be achieved in a resonant converter by associating a resonant inductor-capacitor (LC) circuit with the switching transistor to render its current near sinusoidal rather than square wave in shape. The switching transistor is configured to turn on and off at zero crossings of the current wave. Thus, there is no overlap of falling current and rising voltage at turn-on and substantially no switching losses.

Circuits which turn on and off at zero current may be referred to as zero current switching (ZCS) circuits. However, switching losses can occur at turn-on even though there is no overlap of rising voltage and falling current at the zero crossing of the current sine wave. Considerable energy may be stored on the relatively large output capacity of an output transistor. When the transistor is turned on, it dissipates power in the transistor. Zero voltage switching (ZVS) circuits ensure that the transistor output capacity includes the capacitor of a resonant LC circuit. The voltage or energy stored on the capacitor when the transistor is turned off is changed to stored current or energy in the inductor of the resonant circuit. Then later in the cycle, this energy is returned without loss to the power supply bus.

An LLC resonant converter has become popular for its soft switching nature that offers high efficiency and good electromagnetic interference performance, and for variable period or frequency modulation mechanism to accommodate a wide input voltage range. For high load current applications, synchronous driving of the secondary side field effect transistors (FETs) is necessary to maintain high efficiency. Various driver and controllers have been used for this purpose, based on detections of the voltage and current information of the synchronous FET to decide timings of the turn on and turn off. Due to the propagation delay and consideration to be safe, the timings are often preset with conservative margins, resulting in lower efficiency. These reactive drivers and controllers themselves have limited performance on the propagation delay and thus a limited maximum operation frequency. There are heretofore unaddressed needs with previous resonant converters.

### SUMMARY

Example embodiments of the present disclosure provide systems and methods of resonant DC/DC conversion. Briefly described, in architecture, one example embodiment of the system, among others, can be implemented as follows: a controller configured to set an off-state timing of an output switching frequency if the switching frequency is greater than a resonant frequency, the off-state timing set according to a lookup table.

Embodiments of the present disclosure can also be viewed as providing methods of resonant DC/DC conversion. In this regard, one embodiment of such a device, among others, can be broadly summarized by the following: determining if a switching frequency of a DC/DC converter is greater than a resonant frequency of the converter; if the switching frequency is greater than the resonant frequency, setting a turn-off register according to a switching period lookup table; and driving an output switching transistor to turn off according to the value set in the turn-off register.

### BRIEF DESCRIPTION OF THE DRAWINGS

FIG. 1 is a circuit diagram of an example embodiment of a prior art resonant DC/DC converter.

FIG. 2 is a circuit diagram of an example embodiment of a resonant circuit used in the resonant DC/DC converter of FIG. 1.

FIG. 3 is a circuit diagram of an example embodiment of a system of resonant DC/DC conversion.

FIG. 4 is a circuit diagram of an example embodiment of a controller system of resonant DC/DC conversion.

FIG. 5 is a flow diagram of an example embodiment of a method of resonant DC/DC conversion.

### DETAILED DESCRIPTION

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

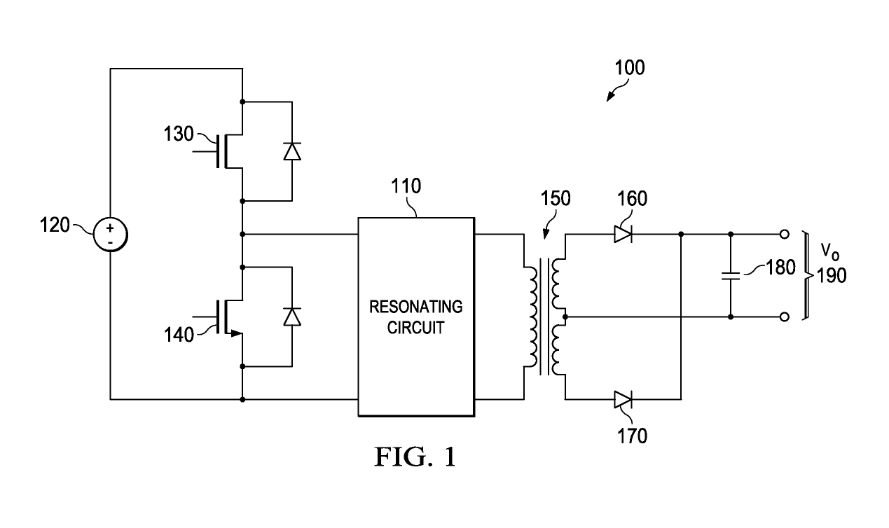

FIG. 1 provides circuit 100 of a resonant DC/DC converter. Circuit 100 includes resonating circuit 110, input source 120, switching transistors 130 and 140, transformer 150, diodes 160 and 170, output capacitor 180 and output voltage 190. Transformer 150 separates the primary side with input voltage 120 from the secondary side with output voltage 190. On the primary side, control is provided with transistors 130 and 140. Transistors 130 and 140 are shown as metal oxide semiconductor field effect transistors (MOSFETs or FETs), but could be fabricated using one or more transistor technologies such as, but not limited to, bipolar, complimentary metal oxide semiconductor (CMOS), and biFET, among others as well. Resonating circuit 110 sets the resonant frequency of the DC/DC converter. On the secondary side, diodes 160 and 170 provide rectification, with filtering for output 190 provided at least by capacitor 180.

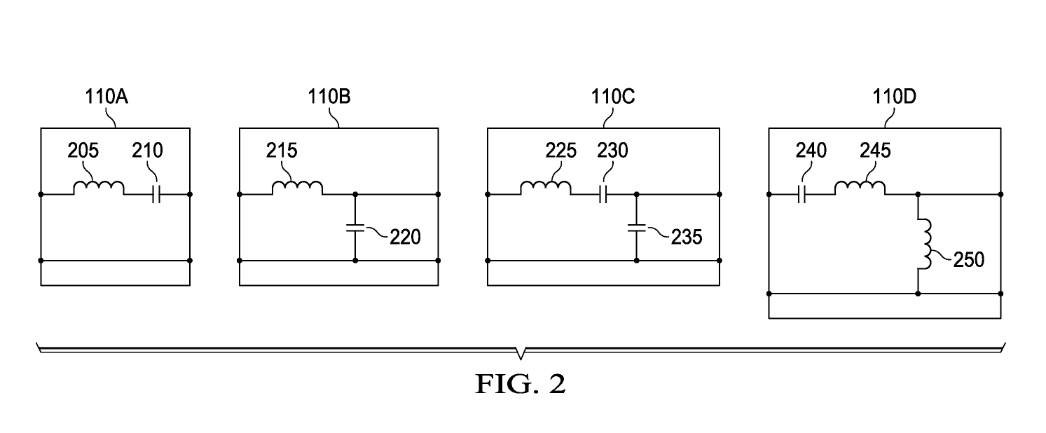

Resonating circuit 110 as provided in FIG. 2, may include one of several resonating circuit topologies, including but not limited to series resonant converter (SRC) 110A, parallel resonant converter (PRC) 110B, series parallel resonant converter (SPRC, also called LCC resonant converter) 110C, and LLC resonant converter 110D.

In a resonant converter using SRC 110A, resonant inductor 205 and resonant capacitor 210 are in series. They form a series resonant tank. The resonant tank will then be in series with the load. From this configuration, the resonant tank and the load act as a voltage divider. By changing the frequency of the input voltage, the impedance of resonant tank will change. This impedance will divide the input voltage with load. Since it is a voltage divider, the DC gain of SRC 110A is always lower than 1. At resonant frequency, the impedance of SRC 100A will be very small; all the input voltage will drop on the load. So for SRC 110A, the maximum gain happens at resonant frequency. Zero voltage switching (ZVS) is preferred for this converter. When the switching frequency is lower than the resonant frequency, the converter will work under zero current switching (ZCS) condition. When the DC gain slope is negative; the converter is working under zero voltage switching condition. When the DC gain slop is positive, the converter will work under a zero current switching condition. For power MOSFETs, zero voltage switching is preferred.

In a resonant converter using PRC 110B, the resonant tank, including inductor 215 and capacitor 220, is still in series. It is called parallel resonant converter because in this case the load is in parallel with the resonant capacitor. More accurately, this converter should be called series resonant converter with parallel load. Since the load is in parallel with the resonant capacitor, even at no load condition, the input may still see a fairly small impedance of the series resonant tank. This will induce high circulating energy even when the load is zero.

In a resonant converter using LCC 110C, the resonant tank consists of three resonant components: inductor 225, capacitor 230, and capacitor 235. The resonant tank of LCC 110C can be looked as the combination of SRC 110A and PRC 110B. Similar to PRC 110B, an output filter inductor may be added on the secondary side to match the impedance. LCC 110C combines the good characteristics of PRC 110B and SRC 110A. With the load in series with series tank inductor 225 and capacitor 230, the circulating energy is smaller than with PRC 110B. With the parallel capacitor 235, LCC 110C can regulate the output voltage at no load condition. LCC 110C combines the good characteristics of SRC 110A and PRC 110B, including smaller circulating energy and less sensitivity to load change. Unfortunately, LCC 110C may still experience a big penalty with wide input range design. With wide input range, the conduction loss and switching loss will increase at high input voltage. The switching loss is similar to that of a PWM converter at high input voltage.

In a resonant converter using LLC 110D, the resonant tank consists of three resonant components: capacitor 240, inductor 245, and inductor 250. The DC characteristics of an LLC resonant converter could be divided into a ZVS region and a ZCS region. For this converter, there are two resonant frequencies. One may be determined by resonant components inductor 245 and capacitor 240. The other resonant frequency may be determined by inductor 250, capacitor 240, and the load conditions. The two resonant frequencies are:

fr1=1/(2π√(L₁C))

fr2=1/(2π√((L₁₊L₂)C))

The switching frequency could be selected as the resonant frequency of fr1, which is a resonant frequency of series resonant tank of capacitor 240 and inductor 245. When the input voltage drops, more gain can be achieved with a lower switching frequency. With proper selection of the resonant tank values, the converter could operate within the ZVS region for load and line variation. The preferred operating frequency may be between fr2 and a multiple of fr1. The voltage modulation voltage gain is higher when the switching frequency moves closer to fr2. The voltage modulation gain change is more significant between fr2 and fr1 than when it is above fr1.

Using these principles, a converter may be designed to operate at the resonant frequency of SRC to achieve high efficiency. Then the converter may be operated lower than resonant frequency, and still operate with ZVS. In an example embodiment, fr1 is the reference resonant frequency for determining whether the switching frequency is above or below the resonant frequency.

The systems and methods of resonant DC/DC conversion disclosed herein improve the basic resonant converter designs by proactively setting and coordinating the gate drive timings between the primary side and secondary side. Optimized performance and efficiency may be achieved in most operation conditions such as steady state operations at a certain high load.

In high load current applications, LLC half bridge resonant converters with synchronous rectifier FETs may be used to achieve high efficiency. By proactively setting and coordinating gate drives timings between the primary side and secondary side, both efficiency and transient performance optimizations may be achieved with or without diode emulation mode, depending on whether the switching frequency is below resonance or above resonance, and the nature of the load characteristics. With the intelligence of a digital controller, low cost gate drivers may be used as alternatives of the sophisticated synchronous FET drivers.

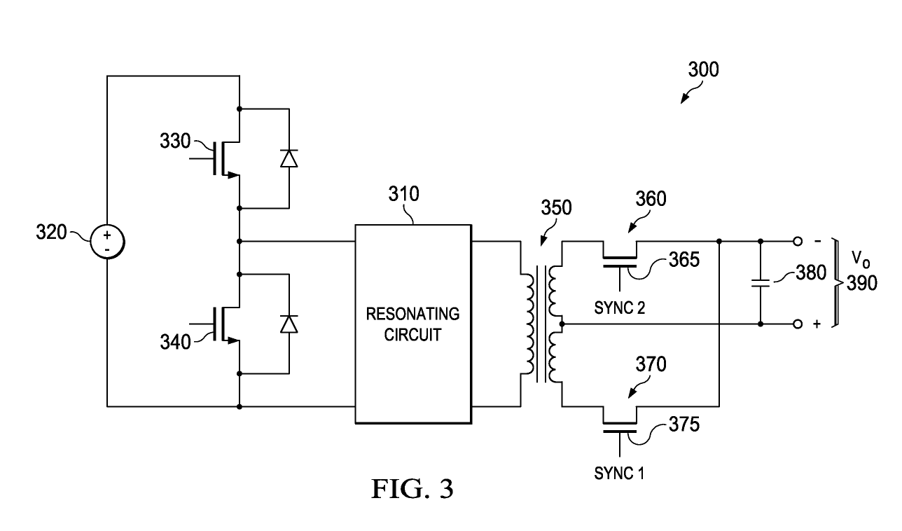

FIG. 3 provides an example embodiment of circuit 300 used to implement the disclosed systems and methods of resonant DC/DC conversion. Transformer 350 separates the primary side with input voltage 320 from the secondary side with output voltage 390. On the primary side, control is provided with transistors 330 and 340. Transistors 330 and 340 are shown as metal oxide semiconductor field effect transistors (MOSFETs or FETs), but could be fabricated using one or more transistor technologies such as, but not limited to, bipolar, complimentary metal oxide semiconductor (CMOS), and biFET, among others as well. Resonating circuit 310 sets the resonant frequency of the DC/DC converter.

On the secondary side, transistors 360 and 370 provide synchronous rectification, with filtering for output 390 provided at least by capacitor 380. Capacitor 380 aids in filtering output voltage 390 and provides instantaneous AC current upon load change. Transistors 360 and 370 are shown as metal oxide semiconductor field effect transistors (MOSFETs or FETs), but could be fabricated using one or more transistor technologies such as, but not limited to, bipolar, complimentary metal oxide semiconductor (CMOS), and biFET, among others as well. Control of transistors 360 and 370 is provided through control lines 365 and 375. In the case of FETs as shown in FIG. 3, control lines 365 and 375 are connected to the gates of transistors 360 and 370 respectively.

As provided in FIG. 3, synchronous FETs 360 and 370 are used on the secondary side of transformer 350. Synchronous FETs 360 and 370 may be set to be fully actively at or above a specified load current for normal operation. If the switching frequency of the converter is determined to be at or below the resonance frequency, synchronous FETS 360 and 370 may be configured to be fully active at or above a predetermined output load current. The turn-on timing of the synchronous FETS 360 and 370 is dependant on the load for a given output voltage 390, and is almost independent of input voltage 320. Turn-on timing may be significantly different at light load to no load.

Synchronous FETS 360 and 370 may be turned on early, even to fully active, at light load to no load. The early turn-on timing may change the contributions to the magnetizing current from the primary side and the secondary side. Recognizing that the magnetizing inductance of transformer 350 is significant lower than that of a typical transformer in a half bridge configuration, the magnetizing inductance can be used as an energy storage device. The turn-off timing of synchronous FETS 360 and 370, however, is substantially independent of the load and also independent of input voltage 320 for a given output voltage 390. Given these characteristics, for a light load condition, synchronous FETs 360 and 370 may be controlled in one or more ways.

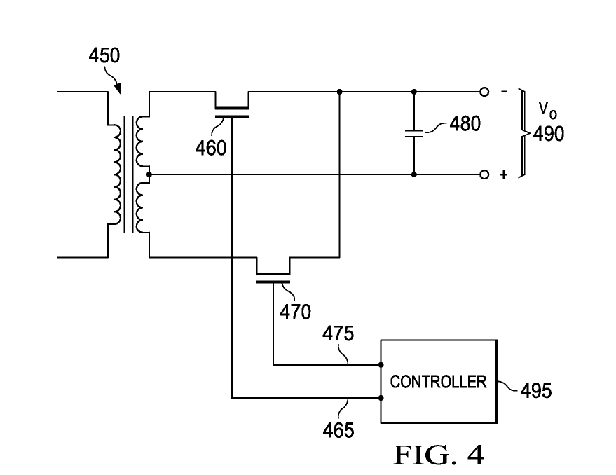

In a first example configuration, diode emulation mode is implemented in which the load current is sampled. Predetermined turn on rising edge delays (turn on angles) for synchronous FETs 360 and 370 are implemented based on the sensed load current. As provided in FIG. 4, controller 495 drives the gates of synchronous FETs 460 and 470 on the secondary side of transformer 450 to set output voltage 490. Synchronous FETs 460 and 470 are driven from controller outputs 465 and 475. Capacitor 480 aids in filtering output voltage 490 and provides instantaneous AC current upon load change. The turn-on rising edge delays may be determined, for example, through a look-up table. An example embodiment of the look-up table may be:

const Uint16 sync_rising_edge_table[11] =
{
// high res, each unit represents 250ps

| | //load |
|---|---|
| 3000, | //0A |
| 1788, | //1A |
| 1612, | //2A |
| 1435, | //3A |
| 1259, | //4A |
| 1082, | //5A |
| 906, | //6A |
| 729, | //7A |
| 553, | //8A |
| 376, | //9A |
| 200 | //10A and above |

};

In this example embodiment, the rising edge delay is 250 picoseconds times the value in the table. So, for a 1 A load, the rising edge or turn-on delay is 250×1788 picoseconds, or 447000 ps or 447 ns. The look-up table may be resident on the controller in internal memory, or it may reside in memory external to the controller. The look-up table may be accessed remotely as well. In this way, the efficiency at light load is expected to be highest with proper programming. The small signal characteristics, however, will be discontinuous mode.

In a second example configuration, a fixed turn-on rising edge delay is implemented similar to the rising edge delay used in full load operation. In this way, the efficiency at light load is expected to be low because of the circulating energy into and out of transformer 350 and inductor 250. The small signal characteristics, however, may be continuous mode all the way down to no load condition.

In a third example configuration, the resistive channel of synchronous FETs 360 and 370 are turned off and the body diodes of FETS 360 and 370 or an external Schottky diode performs the rectification. This third configuration is feasible when the heat dissipation capability is sufficient. When the dead time of the switching frequency increases, the duty cycle of the switching frequency decreases, and the resonant current through the synchronous FET/Schottky diode may conduct two or three times, or more, in each switching cycle for example.

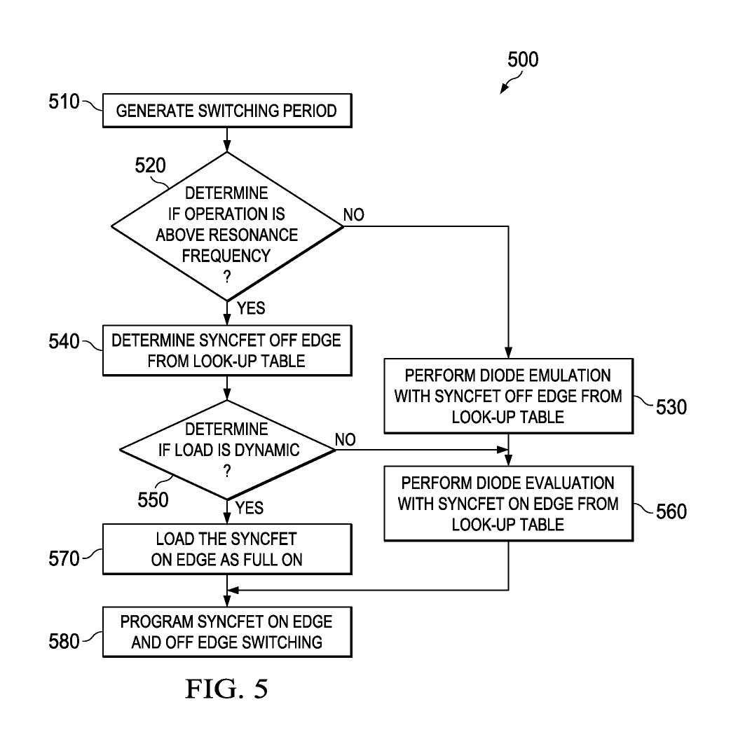

FIG. 5 provides flow chart 500 of an example embodiment of a method of resonant DC/DC conversion. In block 510, an initiation switching period is generated. The initial switching period may be calculated by a digital filter in controller 495. In decision block 520, a determination is made as to whether the operation of the converter is above the resonant frequency of the converter. If the switching frequency is below the resonant frequency, in block 530, the turn-off timing register of the synchronous FETs is set to operate in diode emulation mode. When diode emulation is enabled, synchronous FET 370 is full on. It conducts like a diode, but the FET has much lower R_{dson} than a diode. Then, in block 560, the turn-on timing register of the synchronous FETs is set to diode emulation mode. In an example embodiment, a control algorithm turns on synchronous FETs 360 and 370 for a predetermined time duration according to the on-edge and off-edge values from the look-up table. If the switching frequency is above the resonant frequency, in block 540, the turn-off timing register is set using values in a look-up table. An example embodiment of the switching period look-up table is:

#pragma DATA_SECTION(deadtime_table,“.dflash”)
const Uint16 deadtime_table[5][6] =
{

| | | | | | | | |
|---|---|---|---|---|---|---|---|
| // | 0-4A | 4-10A | 10-15A | 15-20A | 20-25A | 25-30A | <--lout |
| | {1440 | 740 | 730 | 680 | 660 | 660}, | // >587KHz |
| | {1340 | 740 | 720 | 680 | 660 | 660}, | // 525-587KHZ |
| | {1240 | 760 | 710 | 680 | 660 | 660}, | // 462-525KHz |
| | {1200 | 800 | 710 | 685 | 660 | 650}, | // 400-462KHz |
| | {940 | 940 | 940 | 940 | 940 | 940}, | // <400KHz |

};

This is a two-dimensional table giving dead-time for various load current and switching frequency values. Using this table, the turn-off edge may be effectively determined by one half of the switching period minus the dead time specified in the look-up table. In a particular application in which the input voltage is clamped at 420V, for example, not all of the values in the table will be used, i.e., at up right corner of the table with high load and high switching during normal operation as they are invalid cases for closed loop controls.

In an alternative embodiment, the timing registers may be set using an interpolation algorithm. The load current and switching period can be analyzed in the controller, and the timing values can be interpolated using formulas loaded in the controller memory. In block 550, a determination is made as to whether the output load current is dynamic. In an example embodiment, the output current may be sensed on the upstream side of output capacitor 390 (which may include some parasitic inductance). Alternatively, the output current may be sensed on the downstream side of output capacitor 390. A dynamic load can be determined by detecting the rate of change of the load current. In an example embodiment, the load current may be sensed and fed to the analog to digital converters. If the absolute value of the difference between adjacent sample groups is higher than a predetermined reference value with a reasonable hysteresis, then a dynamic load event may be determined.

If the load is dynamic, in block 570, the turn-on timing register of the synchronous rectifier stage is set to full on. In an example embodiment, full on relates to the same on and off edges as those in the case of full load. Full on operation is only recommended for the LLC converter resonant converter or other resonant converters with an effective low inductance in parallel to the main transformer, but generally not in SRC, PRC or LCC whose main transformers are regular transformer with a fairly high magnetizing inductance. The low inductance can be used without the risk of saturation to store the sinking energy induced by the full on operation in which current could be sunk into the transformer from the secondary side. This will work for the LLC converter, but not the other three. The diode emulation operation may be used for the SRC, PRC and LCC for many applications with pseudo-static load, such as in battery charging, electric heating, and certain lighting applications, as non-limiting examples.

If the load is not dynamic, in block 560, the turn-on timing register of the synchronous FETs is set to diode emulation mode. Again, when diode emulation is enabled, the driver allows discontinuous conduction mode by conducting it like a diode with predetermined time duration, but the FET has much lower R_{dson} than a diode. After the turn-on and turn-off registers are set, in block 580, synchronous FETS 360 and 370 are driven using input lines 365 and 375 using the timing set in the registers.

The systems and methods of resonant DC/DC conversion disclosed herein are proactive with the coordination of the primary side timing and the secondary side timing. In an example device embodiment, frequency information such as the switching period information internal to the device, may be used to accurately determine whether the switching frequency is below resonance or above resonance. The sensed load information has less slew rate anomalies than the sensed on-state current of the synchronous FETS 360 and 370 or the on-state drain to source (V_{DS}) information, which have high slew rates. Higher slew rates lead to higher delay timing and lower efficiency.

Therefore, at least the following is claimed:

1. A method comprising:
determining if a switching frequency of a DC/DC converter is greater than a resonant frequency of the converter;
if the switching frequency is greater than the resonant frequency, setting a turn-off register according to a lookup table; and
driving an output switching transistor to turn off according to the value set in the turn-off register.

2. The method of claim 1, further comprising if the switching frequency is less than the resonant frequency, setting the turn-on register to operate the output switching transistor in diode emulation mode.

3. The method of claim 1, further comprising if an output load of the DC/DC converter is not dynamic, setting a turn-on register according to a lookup table.

4. The method of claim 3, further comprising driving the output switching transistor according to the turn-on register.

5. The method of claim 1, further comprising if an output load of the DC/DC converter is dynamic, setting a turn-on register to full on.

6. The method of claim 5, wherein the resonant frequency is set using an inductor-inductor-capacitor (LLC) tank circuit.

7. A power supply circuit, comprising:
a DC/DC converter with a resonant frequency comprising at least one output transistor, the at least one output transistor electrically connected to a controller, the at least one output transistor turned on and off by the controller, the controller setting on-state timing according to sensed load current.

8. The power supply circuit of claim 7, wherein the controller further sets off-state timing according to whether a switching frequency of the at least one output transistor is above the resonant frequency.

9. The power supply circuit of claim 7, wherein a resonant frequency of the resonant DC/DC converter is set by an inductor-inductor-capacitor (LLC) tank circuit.

10. The power supply circuit of claim 7, wherein, when the sensed load current is determined to be dynamic, the controller sets the at least one output transistor to a full-on state.

11. The power supply circuit of claim 7, wherein the at least one output transistor is on the secondary side of a transformer.

12. The power supply circuit of claim 7, further comprising a second output transistor.

13. The power supply circuit of claim 7, wherein on and off timing of the output transistor is calculated using an interpolation algorithm.

14. A system, comprising:
a controller configured to set an off-state timing of an output switching frequency of a resonant converter, wherein if the switching frequency is greater than a resonant frequency, the off-state timing is set according to a lookup table.

15. The system of claim 14, wherein the controller further sets on-state timing according to sensed load current.

16. The system of claim 15, wherein, when the sensed load current is determined to be dynamic, the controller sets the at least one output transistor to a full-on state.

17. The system of claim 14, wherein the resonant frequency is set by an inductor-inductor-capacitor (LLC) tank circuit.

18. The system of claim 14, wherein the controller is further configured to drive at least one transistor to switch at the switching frequency.

19. The system of claim 14, wherein values in the lookup table are updated according to an interpolation algorithm.

20. The system of claim 14, wherein the switching frequency is determined based on switching frequency information, the switching frequency information comprising switching period information.
